(19) United States
(12) Patent Application Publication
(10) Pub. No.: US 2008/0184819 A1
(43) Pub. Date: Aug. 7, 2008

(54) CAPACITANCE TYPE SENSOR

(75) Inventor: Hideo Morimoto, Nara (JP)

Correspondence Address: OSHA LIANG L.L.P., 1221 MCKINNEY STREET, SUITE 2800, HOUSTON, TX, 77010, US

(73) Assignee: Nitta Corporation, Osaka (JP)

(21) Appl. No.: 11/868,167

(22) Filed: Oct. 5, 2007

(30) Foreign Application Priority Data
Oct. 11, 2006 (JP) 2006-277058

(51) Int. Cl. G01L 1/14

(52) U.S. Cl. 73/862.626

(57) ABSTRACT

A capacitance type sensor includes a first flange having four flexible portions and fixed to a base 300; and a second flange having four flexible portions and being opposed to the first flange. A connecting shaft standing at the center of each flexible portion of the first flange is connected to a connecting shaft standing at the center of each flexible portion of the second flange. A pair of electrodes E11 and E12; a pair of electrodes E21 and E22; a pair of electrodes E31 and E32; and a pair of electrodes E41 and E42 are fixed on the upper face of the base 300. The sets of pairs of electrodes, flexible portions of the first flange, flexible portions of the second flange, and connecting shafts are arranged around the Z-axis at regular angular intervals of 90 degrees at the same distance from the Z-axis.

### CROSS REFERENCE TO RELATED APPLICATION

This application claims priority from Japanese Patent Application No. 2006-277058 filed on Oct. 11, 2006.

### BACKGROUND OF THE INVENTION

1. Field of the Invention

The present application relates to a capacitance type sensor that can detect a multiaxial force.

2. Description of Related Art

Japanese Patent Unexamined Publication No. 2004-325367 discloses a force sensor that can detect forces on the X-, Y-, and Z-axes and moments around the respective axes. The force sensor detects the forces and moments on the basis of changes in the capacitance values of the capacitance elements formed between five fixed electrodes E1 to E5 and a disk-shaped diaphragm. The fixed electrodes E1 and E2 correspond to the X-axis; the fixed electrodes E3 and E4 correspond to the Y-axis; and the fixed electrode E5 correspond to the Z-axis.

However, when electrodes are separately provided for detecting forces on the X-, Y-, and Z-axes, it increases the number of electrodes disposed in a predetermined area. This decreases the area of each electrode corresponding to each axis, and thus reduces the capacitance value of the capacitance element constituted by each electrode. As a result, the sensitivity of the sensor becomes bad. In particular, for miniaturizing the sensor, the area of each electrode must be more decreased. This leads to an increase in the ratio of the area or length of each wire to the area of each electrode. This increases the ratio of floating capacitance to each detecting capacitance element. This is a cause of a remarkable reduction in the sensitivity of the sensor.

### SUMMARY OF THE INVENTION

A principal object of the present invention is to provide a capacitance type sensor that can be miniaturized without reducing the sensitivity of the sensor.

According to a first aspect of the present invention, there is provided a capacitance type sensor wherein the sensor comprises a pair of electrodes disposed on a plane; a first flexible portion being opposed to the pair of electrodes so as to cooperate with each electrode to form a capacitance element; a first member having the first flexible portion; a second member having a second flexible portion being opposed to the first flexible portion; and an interconnecting member interconnecting the first and second flexible portions, and the sensor detects a force parallel to the arrangement of the pair of electrodes on the plane and a force perpendicular to the plane on the basis of changes in the capacitance values of the capacitance elements respectively corresponding to the pair of electrodes.

According to the invention, the sensor can detect the force parallel to the arrangement of the pair of electrodes on the plane and the force perpendicular to the plane by using the pair of electrodes disposed on the plane. Thus, it is not necessary to separately provide electrodes for detecting the forces in the above two directions. By sharing the pair of electrodes, each electrode for detecting the forces in the above two directions can have a relatively large area. Therefore, even when the sensor is miniaturized, the ratio of the area or length of each wire to the area of each electrode is prevented from increasing. This prevents the sensitivity of the sensor from reducing.

In the capacitance type sensor of the present invention, the sensor may comprise a plurality of sets of pairs of electrodes, first flexible portions, second flexible portions, and interconnecting members, and the plurality of sets of pairs of electrodes, first flexible portions, second flexible portions, and interconnecting members may be arranged around a center point on the plane at regular angular intervals at the same distance from the center point.

According to the above feature of the invention, a force having multiaxial components can be detected, that is, multiaxial forces and moments can be detected.

In the capacitance type sensor of the present invention, the angular interval may be 90 degrees.

According to the above feature of the invention, orthogonal components, forces perpendicular to them, and moments can be detected.

In the capacitance type sensor of the present invention, the pairs of electrodes and the first flexible portions in the plurality of sets may be disposed at positive and negative positions on X- and Y-axes with an origin being set at the center point.

According to the above feature of the invention, X- and Y-axial forces and moments with the origin being set at the center point on the plane can be detected.

In the capacitance type sensor of the present invention, the pair of electrodes disposed at the positive and negative positions on the X-axis may be Y-axially distant from each other so as to be symmetrical with respect to the X-axis; and the pair of electrodes disposed at the positive and negative positions on the Y-axis may be X-axially distant from each other so as to be symmetrical with respect to the Y-axis.

According to the above feature of the invention, the X- and Y-axial forces and moments with the origin being set at the center point on the plane can easily be detected.

In the capacitance type sensor of the present invention, the angular interval may be 120 degrees.

According to the above feature of the invention, in comparison with the case of the angular interval of 90 degrees, the number of electrodes disposed on the plane, and the number of flexible portions of the first and second members are reduced. This reduces the manufacturing cost.

In the capacitance type sensor of the present invention, the pairs of electrodes and the first flexible portions in the plurality of sets may be disposed on a first line making an angle of 30 degrees from a positive portion of an X-axis toward a negative portion of a Y-axis with an origin being set at the center point; on a second line making an angle of 30 degrees from a negative portion of the X-axis toward the negative portion of the Y-axis; and at a positive position on the Y-axis.

In the capacitance type sensor of the present invention, the pair of electrodes disposed on the first line may be distant from each other perpendicularly to the first line so as to be symmetrical with respect to the first line; the pair of electrodes disposed on the second line may be distant from each other perpendicularly to the second line so as to be symmetrical with respect to the second line; and the pair of electrodes disposed at the positive position on the Y-axis may be X-axially distant from each other so as to be symmetrical with respect to the Y-axis.

### BRIEF DESCRIPTION OF THE DRAWINGS

Other and further objects, features and advantages of the invention will appear more fully from the following description taken in connection with the accompanying drawings in which:

FIG. 1 is a central vertical sectional view of a capacitance type sensor according to a first embodiment of the present invention;

FIG. 2 is a sectional view taken along line A-A in FIG. 1;

FIG. 3 shows the arrangement of electrodes;

FIG. 4 shows a state of the capacitance type sensor when an X-axial force Fx is applied;

FIG. 5 shows a state of the capacitance type sensor when a Z-axial force Fz is applied;

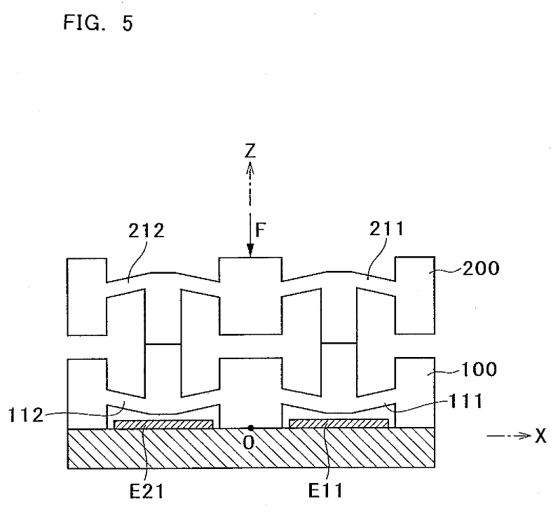

FIG. 6 shows a state of the capacitance type sensor when a moment My around the Y-axis is applied;

FIG. 7 shows the arrangement of electrodes of a capacitance type sensor according to a second embodiment of the present invention; and

FIG. 8 shows decomposition to X-, Y-, and Z-axial vectors.

### DESCRIPTION OF THE PREFERRED EMBODIMENTS

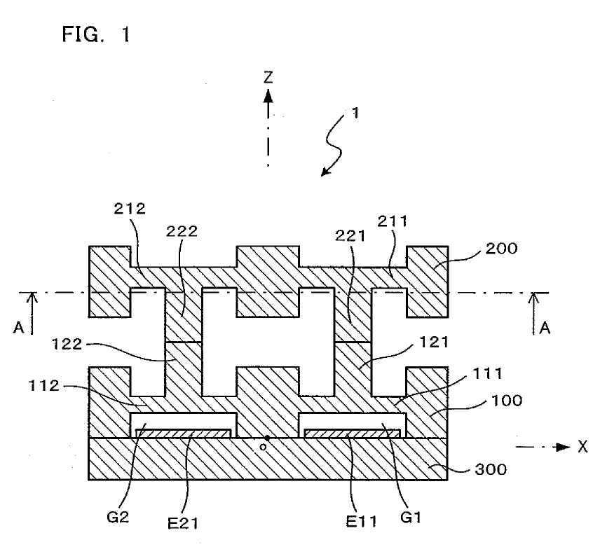

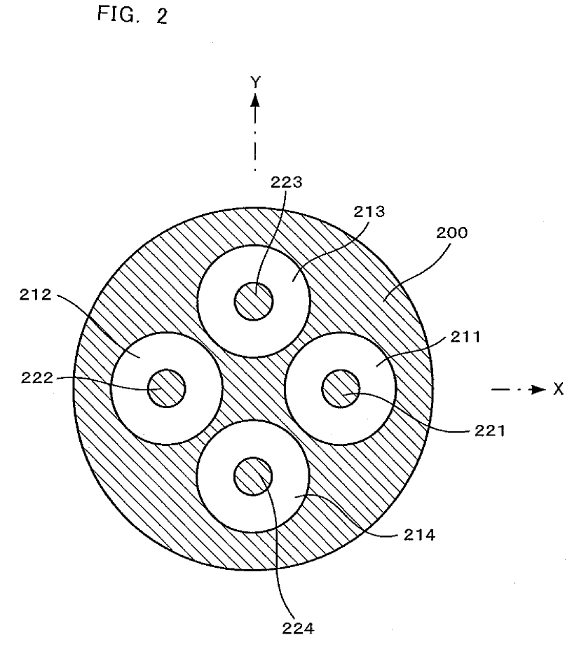

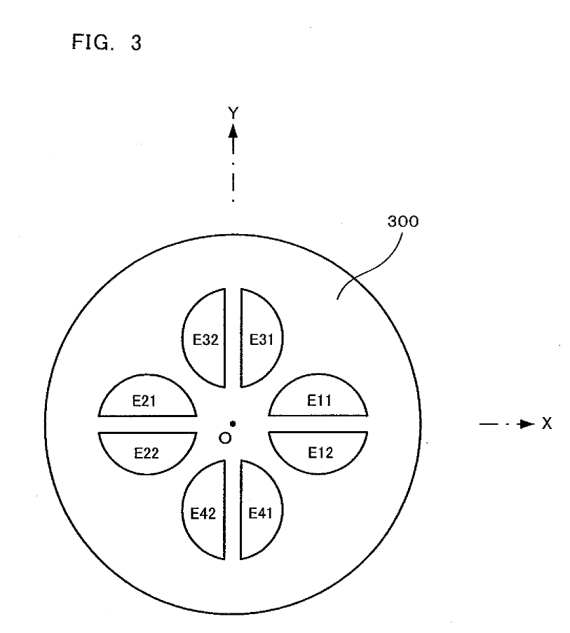

Hereinafter, preferred embodiments of the present invention will be described with reference to the drawings. FIG. 1 is a central vertical sectional view of a capacitance type sensor according to a first embodiment of the present invention. FIG. 2 is a sectional view taken along line A-A in FIG. 1. FIG. 3 shows the arrangement of electrodes.

The capacitance type sensor 1 of FIG. 1 includes a first flange 100 fixed to a sufficiently rigid base 300; and a second flange 200 disposed so as to be opposed to the first flange 100. The base 300 is formed into a disk shape. The first flange 100 is supported by a peripheral portion and a central portion of the base 300. Either of the first and second flanges 100 and 200 is made of metal or the like, and formed into a disk shape. The first flange 100 has four thin flexible portions 111 to 114. Connecting shafts 121 to 124 stand at the centers of the flexible portions 111 to 114, respectively. Likewise, the second flange 200 has four thin flexible portions 211 to 214. Connecting shafts 221 to 224 stand at the centers of the flexible portions 211 to 214, respectively, as shown in FIG. 2.

The connecting shafts 121 to 124 are respectively connected to the connecting shafts 221 to 224 by suitable means such as bolts. Thereby, the flexible portions 111 to 114 and connecting shafts 121 to 124 of the first flange 100 are substantially symmetrical to the flexible portions 211 to 214 and connecting shafts 221 to 224 of the second flange 200, respectively. Because the connecting shafts 121 to 124 are tightly connected to the connecting shafts 221 to 224, respectively, the first and second flanges 100 and 200 can operate as one body.

As shown in FIG. 3, a pair of electrodes E11 and E12; a pair of electrodes E21 and E22; a pair of electrodes E31 and E32; and a pair of electrodes E41 and E42 are fixed on the upper surface of the base 300. Each electrode is formed into a semicircular shape. The pairs of electrodes are disposed at X- and Y-axial positive and negative positions. The pair of electrodes E11 and E12 disposed at the X-axial positive position; and the pair of E21 and E22 disposed at the X-axial negative position are Y-axially distant from each other symmetrically with respect to the X-axis. The pair of electrodes E31 and E32 disposed at the Y-axial positive position; and the pair of E41 and E42 disposed at the Y-axial negative position are X-axially distant from each other symmetrically with respect to the Y-axis.

The flexible portions 111 to 114 of the first flange 100 are formed so as to be opposed to the respective pairs of electrodes. Circular gaps G1 to G4 are formed at regular angular intervals between the lower face of the first flange 100 and the base 300 so that the electrodes are distant from the respective flexible portions 111 to 114 of the first flange 100. Thus, capacitance elements C11, C12, C21, C22, C31, C33, C41, and C42 are formed between the respective electrodes E11, E12, E21, E22, E31, E32, E41, and E42, and the flexible portions 111 to 114 of the first flange 100.

As described above, the capacitance type sensor 1 has four sets of the pairs of electrodes, the flexible portions of the first flange 100, the flexible portions of the second flange 200, and the connecting shafts. The sets of the pairs of electrodes, the flexible portions of the first flange 100, the flexible portions of the second flange 200, and the connecting shafts, are disposed around the Z-axis at regular angular intervals of 90 degrees, and at the same distance from the Z-axis.

As described above, the first flange 100 has the flexible portions 111 to 114. Therefore, when a force is applied to the second flange 200, the flexible portions 111 to 114 receive forces through the connecting shafts 121 to 124 and 221 to 224. Thereby, the flexible portions 111 to 114 are displaced in accordance with the intensity and direction of the applied three-dimensional force. This changes the capacitance values of the respective capacitance elements. Thus, the capacitance type sensor 1 functions as a six-axis force sensor that measures forces on orthogonal three axes in the three-dimensional space, and moments around the respective axes.

Next, the principle for detecting forces and moments on and around the respective axes will be described. In the below description, it is assumed that the first flange 100 is fixed and the second flange 200 receives a force or moment.

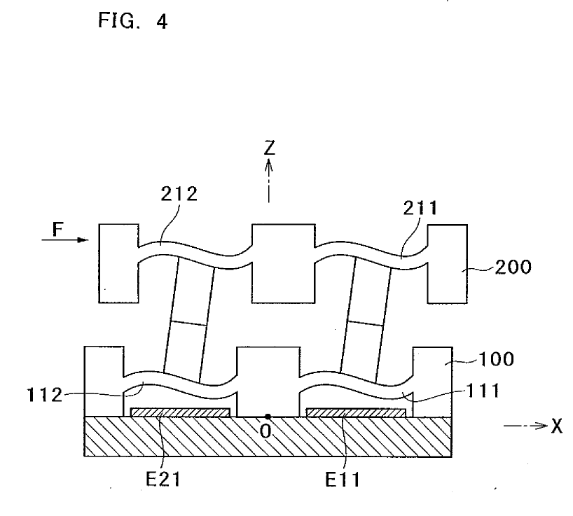

FIG. 4 shows a state of the capacitance type sensor 1 when an X-axial force Fx is applied. In this case, the flexible portions 111 to 114 of the first flange 100 and the flexible portions 211 to 214 of the second flange 200 are displaced as shown in FIG. 4. X-axial positive portions of the flexible portions 113 and 114 of the first flange 100 are displaced to get near to the respective electrodes E31 and E41. The gaps thereby decrease, and therefore the capacitance elements C31 and C41 increase in their capacitance values. On the other hand, X-axial negative portions of the flexible portions 113 and 114 of the first flange 100 are displaced to get away from the respective electrodes E32 and E42. The gaps thereby increase, and therefore the capacitance elements C32 and C42 decrease in their capacitance values. As for each of the capacitance elements C11, C12, C21, and C22, a part of the gap increases while another part of the gap decreases. Therefore, the changes in the capacitance value are cancelled by each other, as a result, the capacitance value scarcely changes.

Next, the case of applying a Y-axial force Fy can be understood by shifting by 90 degrees the state when the X-axial force Fx is applied. Therefore, the description is omitted here.

FIG. S shows a state of the capacitance type sensor 1 when a Z-axial force Fz is applied. The flexible portions 111, 112, 113, and 114 of the first flange 100 are displaced to get near to the respective electrodes E11, E12, E31, and E41. The gaps thereby decrease, and therefore the capacitance elements C11, C12, C31, and C41 increase in their capacitance values.

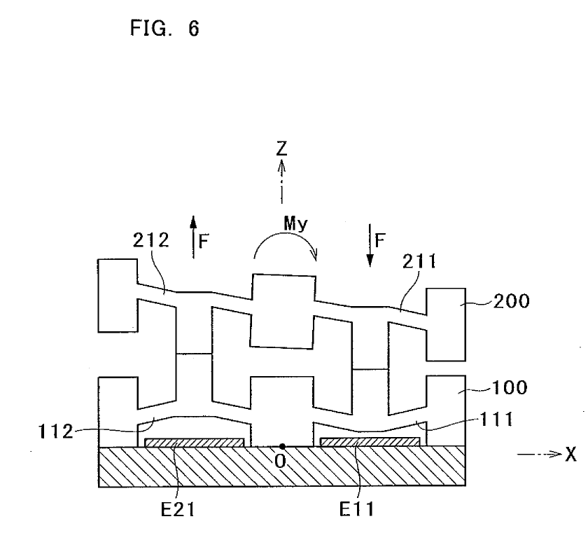

FIG. 6 shows a state of the capacitance type sensor 1 when a moment My around the Y-axis is applied. The flexible portion 111 of the first flange 100 is displaced to get near to the electrodes E11 and E12. The gaps thereby decrease, and therefore, the capacitance elements C11 and C12 increase in their capacitance values. On the other hand, the flexible portion 112 of the first flange 100 is displaced to get away from the electrodes E21 and E22. The gaps thereby increase, and therefore, the capacitance elements C21 and C22 decrease in their capacitance values. The capacitance values of the capacitance elements C31 and C41 scarcely change or somewhat increase. The capacitance values of the capacitance elements C32 and C42 scarcely change or somewhat decrease. In the below description, however, it is assumed that the capacitance values of those capacitance elements scarcely change.

Next, the case of applying a moment Mx around the X-axis can be understood by shifting by 90 degrees the state when the moment My around the Y-axis is applied. Therefore, the description is omitted here.

When a moment Mz around the Z-axis is applied, the connecting shafts 121 to 124 and 221 to 224 are displaced to tilt in the same rotational direction around the Z-axis. A Y-axial negative portion of the flexible portion 111, a Y-axial positive portion of the flexible portion 112, an X-axial positive portion of the flexible portion 113, and a X-axial negative portion of the flexible portion 114 of the first flange 100 are displaced to get near to the respective electrodes E12, E21, E31, and E42. The gaps thereby decrease, and therefore the capacitance elements C12, C21, C31, and C42 increase in their capacitance values. On the other hand, a Y-axial positive portion of the flexible portion 111, a Y-axial negative portion of the flexible portion 112, an X-axial negative portion of the flexible portion 113, and a X-axial positive portion of the flexible portion 114 of the first flange 100 are displaced to get away from the respective electrodes E11, E22, E32, and E41. The gaps thereby increase, and therefore the capacitance elements C11, C22, C32, and C41 decrease in their capacitance values.

Table 1 shows the changes in the capacitance values of the capacitance elements when the above-described forces and moments are applied. In Table 1, “+” represents an increase in capacitance value; “−” represents a decrease in capacitance value; and “0” represents that the capacitance value scarcely changes. In the case of a force or moment in the reverse direction, the sign is inverted.

TABLE 1

| | Force/moment | | | | | | | |
|---|---|---|---|---|---|---|---|---|
| | C11 | C12 | C21 | C22 | C31 | C32 | C41 | C42 |
| Fx | 0 | 0 | 0 | 0 | + | − | + | − |
| Fy | + | − | + | − | 0 | 0 | 0 | 0 |
| Fz | + | + | + | + | + | + | + | + |
| Mx | 0 | 0 | 0 | 0 | − | − | + | + |
| My | + | + | − | − | 0 | 0 | 0 | 0 |
| Mz | − | + | + | − | + | − | − | + |

The following facts will be understood from the above changes in the capacitance values of the capacitance elements.

The direction and intensity of a force to Y-axially tilt the connecting shaft 121 can be detected from the difference between C11 and C12. The direction and intensity of a force to Y-axially tilt the connecting shaft 122 can be detected from the difference between C21 and C22. The direction and intensity of a force to X-axially tilt the connecting shaft 123 can be detected from the difference between C31 and C32. The direction and intensity of a force to X-axially tilt the connecting shaft 124 can be detected from the difference between C41 and C42.

The direction and intensity of a force to Z-axially displace the connecting shaft 121 can be detected from the sum of C11 and C12. The direction and intensity of a force to Z-axially displace the connecting shaft 122 can be detected from the sum of C21 and C22. The direction and intensity of a force to Z-axially displace the connecting shaft 123 can be detected from the sum of C31 and C32. The direction and intensity of a force to Z-axially displace the connecting shaft 124 can be detected from the sum of C41 and C42.

The flexible portion 111 being opposed to the electrodes E11 and E12 can be considered to be a set of sensors that can detect two components of the intensities of Y- and Z-axial forces applied to the connecting shaft 121. The flexible portion 112 being opposed to the electrodes E21 and E22 can be considered to be a set of sensors that can detect two components of the intensities of Y- and Z-axial forces applied to the connecting shaft 122. The flexible portion 113 being opposed to the electrodes E31 and E32 can be considered to be a set of sensors that can detect two components of the intensities of X- and Z-axial forces applied to the connecting shaft 123. The flexible portion 114 being opposed to the electrodes E41 and E42 can be considered to be a set of sensors that can detect two components of the intensities of X- and Z-axial forces applied to the connecting shaft 124.

Thus, the capacitance type sensor 1 has a construction in which there are arranged at regular angular intervals four two-axis force sensors each of which can detect a force parallel to the arrangement of the electrodes and a force perpendicular to the electrodes.

From the above facts, the forces and moments can be detected by the calculation of Expression 1.

Fx=(C31−C32)+(C41−C42)

Fy=(C11−C12)+(C21−C22)

Fz=(C11+C12)+(C21+C22)+(C31+C32)+(C41+C42)

Mx=(C41+C42)−(C31+C32)

My=(C11+C2)−(C21+C22)

Mz=(C12−C11)+(C21−C22)+(C31−C32)+(C42−C41) [Expression 1]

The calculations of Expression 1 can be performed by calculating the capacitance values by using a proper method, or may be performed by calculating voltage values converted from the capacitance values. In another method, the converted voltage values may be input to an A/D converter or the like to be converted into digital values to be calculated with a microcomputer or a personal computer. Of course, the calculation method is not limited to Expression 1.

Because the calculation for obtaining Fz only includes addition terms, drifts due to the temperature characteristics of the respective capacitance elements are also added. This may deteriorate the temperature characteristic of Fz. For this reason, when the capacitance values of the capacitance elements are converted into voltage values, that is, C/V-converted, C21, C22, C41, and C43 are converted into voltage values in the reverse polarity to C11, C12, C31, and C32. This improves the temperature characteristic of Fz. Also, converting C11, C12, C21, and C22 into voltage values in the reverse polarity to C31, C32, C41, and C42 improves the temperature characteristic of Fz.

Table 2 shows polarities when the capacitance values of the capacitance elements are converted into voltage values. In Table 2, “+” represents an increase in voltage value; “−” represents a decrease in voltage value; and “0” represents that the voltage value scarcely changes. In the case of a force or moment in the reverse direction, the sign is inverted.

TABLE 2

| | Force/moment | | | | | | | |
|---|---|---|---|---|---|---|---|---|
| | V11 | V12 | V21 | V22 | V31 | V32 | V41 | V42 |
| Fx | 0 | 0 | 0 | 0 | + | − | − | + |
| Fy | + | − | − | + | 0 | 0 | 0 | 0 |
| Fz | + | + | − | − | + | + | − | − |
| Mx | 0 | 0 | 0 | 0 | − | − | − | − |
| My | + | + | + | + | 0 | 0 | 0 | 0 |
| Mz | − | + | − | + | + | − | + | − |

The above Expression 1 is changed into Expression 2 on the basis of Table 2.

Fx=(V31−V32)+(V42−V41)

Fy=(V11−V12)+(V22−V21)

Fz=(V11+V12)−(V21+V22)+(V31+V32)−(V41+V42)

Mx=(V41+V42)+(V31+V32)

My=(V11+V12)+(V21+V22)

Mz=(V12−V11)−(V21−V22)+(V31−V32)−(V42−V41) [Expression 2 ]

In the above Expression 2, because the calculation for obtaining Fz includes addition and subtraction terms, the temperature characteristic of Fz is improved. Either of the calculations for obtaining Mx and My only includes addition terms. However, the number of addition terms is half the number of addition terms of the calculation for obtaining Fz. This can halve the offset quantity because of accumulated temperatures. Therefore, the temperature characteristics are improved comprehensively.

Although six-axial components can be calculated by using Expression 1 or 2, it may be hard to obtain accurate information on forces without additional means because interference increases. Therefore, it is preferable that devices to each of which a single force component can be applied are used to obtain a relation between information on force and an output signal when the load of each signal force component is applied, and thereby accurate information on forces is calculated from the output signals.

When output voltages corresponding to the respective forces Fx, Fy, and Fz and moments Mx, My, and Mz to be applied to the capacitance type sensor 1 are represented by Vfx, Vfy, Vfz, Vmx, Vmy, and Vmz; and loads actually applied to the capacitance type sensor 1 are represented by Fx, Fy, Fz, Mx, My, and Mz, the relation of Expression 3 is obtained.

$$( \begin{matrix}Vfx \\ Vfy \\ Vfz \\ Vmx \\ Vmy \\ Vmz\end{matrix} ) = A ( \begin{matrix}Fx \\ Fy \\ Fz \\ M x \\ My \\ Mz\end{matrix} ) \qquad [ Expression 3 ]$$

where Vfx, Vfy, Vfz, Vmx, Vmy, and Vmz represent the output signals when the forces Fx, Fy, and Fz and moments Mx, My, and Mz are singly applied; and A represents a characteristic matrix.

Both sides of Expression 3 are multiplied from the left by the inverse matrix [A]⁻¹ of the characteristic matrix A to obtain Expression 4.

$$( \begin{matrix}Fx \\ Fy \\ Fz \\ M x \\ My \\ Mz\end{matrix} ) = {A}^{- 1} ( \begin{matrix}Vfx \\ Vfy \\ Vfz \\ vmx \\ Vmy \\ Vmz\end{matrix} ) \qquad [ Expression 4 ]$$

As described above, the capacitance type sensor 1 of this embodiment can detect a force parallel to the base 300 and a force perpendicular to the base 300 by using the pairs of electrodes disposed on the base 300. Thus, it is not necessary to separately provide electrodes for detecting forces in the above two directions. By sharing the pairs of electrodes, each electrode for detecting the forces in the above two directions can have a relatively large area. Therefore, even when the sensor is miniaturized, the ratio of the area or length of each wire to the area of each electrode is prevented from increasing. This prevents the sensitivity of the sensor from reducing. In addition, six-axial forces and moments can be obtained by using four pairs of electrodes or the like disposed at positive and negative positions on the X-axis and positive and negative positions on the Y-axis.

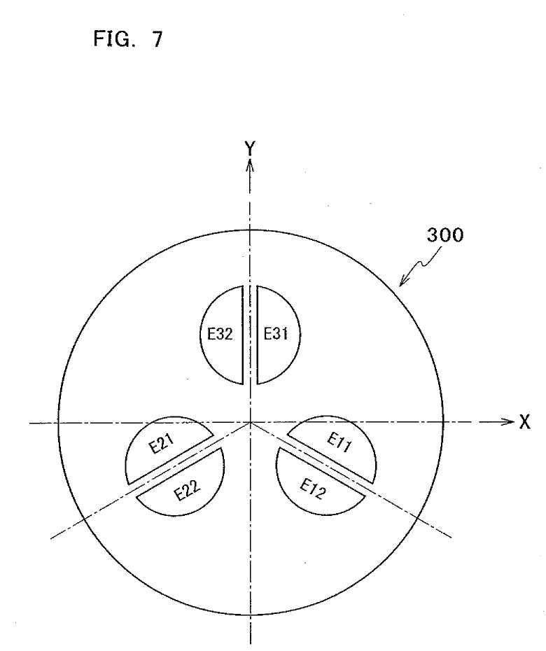

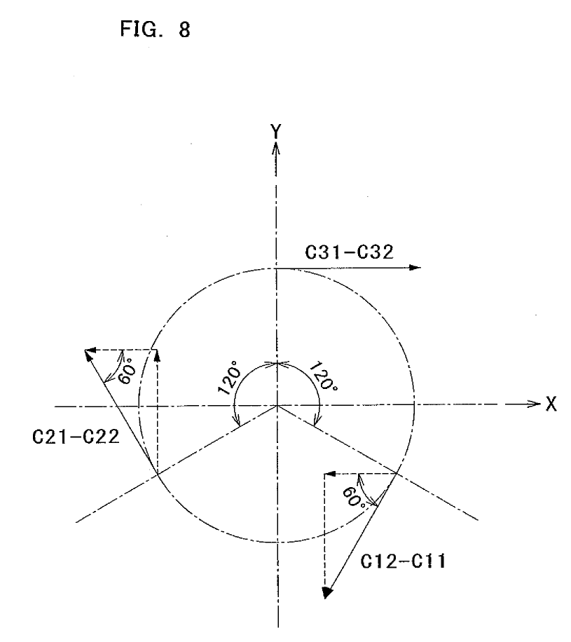

Next, a second embodiment of the present invention will be described with reference to FIGS. 7 and 8. FIG. 7 shows the arrangement of electrodes of a capacitance type sensor according to the second embodiment of the present invention. FIG. 8 shows decomposition to X-, Y-, and Z-axial vectors.

The capacitance type sensor of this embodiment largely differs from the capacitance type sensor 1 of the first embodiment in the arrangement and number of electrodes on the upper face of the base 300. While four pairs of electrodes are arranged at regular angular intervals of 90 degrees in the first embodiment, three pairs of electrodes are arranged at regular angular intervals of 120 degrees in this embodiment. Therefore, either of the first and second flanges has three flexible portions and three connecting shafts at positions corresponding to the respective pairs of electrodes.

Table 3 shows changes in the capacitance values of capacitance elements when forces and moments are applied, like the first embodiment. In Table 3, “+” represents an increase in capacitance value; “−” represents a decrease in capacitance value; and “0” represents that the capacitance value scarcely changes. In the case of a force or moment in the reverse direction, the sign is inverted.

TABLE 3

Force/moment

| | C11 | C12 | C21 | C22 | C31 | C32 |
|---|---|---|---|---|---|---|
| Fx | + | − | − | + | + | − |
| Fy | + | − | + | − | 0 | 0 |
| Fz | + | + | + | + | + | + |
| Mx | + | + | + | + | − | − |
| My | + | + | − | − | + | − |
| Mz | − | + | + | − | + | − |

In this case, the forces and moments can be calculated by using Expression 5.

Fx=(C11−C12)+(C22−C21)+(C31−C32)

Yy=(C11−C12)+(C21−C22)

Fz=C11+C12+C21+C22+C31+C32

Mx=(C11+C12+C21+C22)−(C31+C32)

My=(C11+C21)−(C21+C22)+(C31−C32)

Mz=(C12−C11)+(C21−C22)+(C31−C32) [Expression 5]

In addition, even when the characteristic matrix as described in the first embodiment is not used, interference between axes can be reduced by calculating with decomposing to X-, Y-, and Z-axial vectors.

In this case, the forces and moments can be calculated by using Expression 6, as shown in FIG. 8. However, for accurately calculating the forces and moments, it is preferable to calculate the six-axial forces and moments from the relations of Expressions 3 and 4, like the first embodiment.

Fx=(C11−C12)·½+(C22−C21)·½+(C31−C32)

Fy=(C11−C12)·√3/2+(C21−C22)·√3/2

Fz=C11+C12+C21+C22+C31+C32

Mx=(C11+C12+C21+C22)·1/2−(C31+C32)

My=(C11+C21)·√3/2−(C21+C22)·√3/2

Mz=(C12−C11)+(C21−C22)+(C31−C32) [Expression 6]

Thereby, the same effects as the first embodiment can be obtained.

For example, in the above first and second embodiments, the capacitance type sensors that detect six-axial forces and moments have been described. However, the present invention is not limited to that. The present invention can be applied to a capacitance type sensor that detects six-axial accelerations and angular accelerations, or a two-axis sensor that only detects two-axial forces on the X- and Y-axes. In the above first and second embodiments, the flexible portions of the first flange 100, the flexible portions of the second flange 200, and the connecting shafts are arranged at regular angular intervals of 90 or 120 degrees at the same distance from the Z-axis. However, the present invention is not limited to that. The thicknesses or sizes of the flexible portions 111 to 114 and 211 to 214 may differ from each other though they are preferably the same. A single substrate on which the electrodes have been formed may be fixed on the upper face of the base 300. Otherwise, the substrate may be fixed to the lower face of the first flange 100 with interposing spacers so that the electrodes are respectively opposed to the flexible portions at a distance. The first flange 100 may differ from the second flange 200 in size. Either of the first and second flanges 100 and 200 may be made of conductive silicone rubber or conductive plastic. Each connecting shaft may be formed integrally with the corresponding flange.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A capacitance type sensor characterized in that the sensor comprises:
a pair of electrodes disposed on a plane;
a first flexible portion being opposed to the pair of electrodes so as to cooperate with each electrode to form a capacitance element;
a first member having the first flexible portion;
a second member having a second flexible portion being opposed to the first flexible portion; and
an interconnecting member interconnecting the first and second flexible portions, and
the sensor detects a force parallel to the arrangement of the pair of electrodes on the plane and a force perpendicular to the plane on the basis of changes in the capacitance values of the capacitance elements respectively corresponding to the pair of electrodes.

2. The capacitance type sensor according to claim 1, characterized in that the sensor comprises a plurality of sets of pairs of electrodes, first flexible portions, second flexible portions, and interconnecting members, and
the plurality of sets of pairs of electrodes, first flexible portions, second flexible portions, and interconnecting members are arranged around a center point on the plane at regular angular intervals at the same distance from the center point.

3. The capacitance type sensor according to claim 2, characterized in that the angular interval is 90 degrees.

4. The capacitance type sensor according to claim 3, characterized in that the pairs of electrodes and the first flexible portions in the plurality of sets are disposed at positive and negative positions on X- and Y-axes with an origin being set at the center point.

5. The capacitance type sensor according to claim 4, characterized in that the pair of electrodes disposed at the positive and negative positions on the X-axis are Y-axially distant from each other so as to be symmetrical with respect to the X-axis; and the pair of electrodes disposed at the positive and negative positions on the Y-axis are X-axially distant from each other so as to be symmetrical with respect to the Y-axis.

6. The capacitance type sensor according to claim 2, characterized in that the angular interval is 120 degrees.

7. The capacitance type sensor according to claim 6, characterized in that the pairs of electrodes and the first flexible portions in the plurality of sets are disposed on a first line making an angle of 30 degrees from a positive portion of an X-axis toward a negative portion of a Y-axis with an origin being set at the center point; on a second line making an angle of 30 degrees from a negative portion of the X-axis toward the negative portion of the Y-axis; and at a positive position on the Y-axis.

8. The capacitance type sensor according to claim 7, characterized in that the pair of electrodes disposed on the first line are distant from each other perpendicularly to the first line so as to be symmetrical with respect to the first line; the pair of electrodes disposed on the second line are distant from each other perpendicularly to the second line so as to be symmetrical with respect to the second line; and the pair of electrodes disposed at the positive position on the Y-axis are X-axially distant from each other so as to be symmetrical with respect to the Y-axis.
